(19) United States
(12) Patent Application Publication
(10) Pub. No.: US 2011/0125927 A1
(43) Pub. Date: May 26, 2011

(54) PERSONAL COMPUTER SYSTEM AND OPERATION METHOD THEREOF FOR MULTIPLE OUTPUTS

(75) Inventors: Yi-Hung Shen, Taipei City (TW); Chun-Te Lin, Taipei City (TW)

(73) Assignee: COMPAL ELECTRONICS, INC., Taipei City (TW)

(21) Appl. No.: 12/952,210

(22) Filed: Nov. 23, 2010

Related U.S. Application Data
(60) Provisional application No. 61/263,407, filed on Nov. 23, 2009.

(51) Int. Cl. G06F 3/00

(52) U.S. Cl. 710/3

(57) ABSTRACT

A personal computer system and an operation method thereof for multiple outputs are provided. In the present method, input data generated by each of a plurality of input devices of the personal computer system are received. According to an identification information of each of the input devices, each of the input data is respectively transmitted to one of a plurality of application programs. After that, each of the application programs separately generates an output result according to the received input data and displays the output result on a corresponding application program interface, wherein all of the application program interfaces displaying the corresponding output results are in one and the same display screen of the personal computer system.

### CROSS-REFERENCE TO RELATED APPLICATION

This application claims the priority benefit of U.S. provisional application Ser. No. 61/263,407, filed on Nov. 23, 2009. The entirety of the above-mentioned patent application is hereby incorporated by reference herein and made a part of this specification.

### BACKGROUND OF THE INVENTION

1. Field of the Invention

The invention relates to an operation method of a personal computer system. More particularly, the invention relates to a personal computer system capable of generating multiple output results by using a plurality of input devices and an operation method thereof.

2. Description of Related Art

When operating a computer system, a user relies on an input device to input instructions or data into the computer system, and relies on an output device to read processed results of the computer system. Herein, keyboards and mice are the most basic input devices and monitors are the most common output devices of conventional computer systems.

With the advancement of technology, many computer systems in the market are now capable of connecting multiple monitors simultaneously, such that desktops thereof become more spacious for the user to open more windows for operation. Additionally, in order for the user to input instructions or data more conveniently, the computer system also provides a plurality of ports for the user to externally connect a plurality of keyboards or mice by themselves.

However, regardless of the number of input devices disposed in the computer system, the input devices can only generate an output result. For a computer system disposed with two mice, signals respectively generated by the two mice at the same time can not operate separately and can only control the same active window of the application program. Hence, although disposed with a plurality of input devices and a plurality of output devices, the computer system is only controlled by one user at the same time point.

### SUMMARY OF THE INVENTION

The invention is directed to an operation method of multiple outputs, so that a personal computer system having a plurality of input devices is capable of displaying a plurality of output results in one and the same display screen simultaneously.

The invention is directed to a personal computer system capable of being operated by two or more users simultaneously.

The invention is directed to an operation method of multiple outputs and the operation method is adopted in a personal computer system including a plurality of input devices. The method includes the following steps. An input data respectively generated by each of the input devices is received. Each of the input data is transmitted to one of a plurality of application programs respectively according to an identification information of each of the input devices. Moreover, each of the application programs respectively generates an output result according to the received input data and displays the output result on a corresponding application program interface, wherein all of the application program interfaces displaying the corresponding output results are in one display screen of the personal computer system.

In one embodiment of the invention, the input devices include at least one first type input device and/or at least one second type input device.

In one embodiment of the invention, after the step of receiving the input data generated by each of the input devices, the operation method further includes the following steps. For each of the input devices, when the input device is externally connected to the personal computer system through a port, a port number of the port and a device type are adopted as the identification information of the input device. When the input device is built-in in the personal computer system, the device type is adopted as the identification information.

In one embodiment of the invention, the input devices are a plurality of first type input devices and the personal computer system further includes a second type input device. The operation method further includes the following steps. When a second type input data generated by the second type input device is received, whether the second type input device is assigned to operate one of the application programs is determined. When the second type input device is determined to being assigned to operate one of the application programs, the second type input data is transmitted to the assigned application program. When the second type input device is determined not being assigned to operate any of the application programs, the second type input data is transmitted to one of the application programs according to a usage state of the first type input devices.

In one embodiment of the invention, the step of transmitting the second type input data to one of the application programs according to the usage state of the first type input devices includes the following. It is determined that whether at least one of the first type input devices is in use. When at least one of the first type input devices is determined as being in use, one of the at least one first type input device in use is acquired according to a priority sequence between the first type devices and the second type input data is transmitted to the application program corresponding to the acquired first type input device. When there is no first type input device in use, the application program last receiving an input data of the first type input devices is acquired and the second type input data is transmitted to an acquired application program.

In one embodiment of the invention, the input devices are a plurality of first type input devices and the personal computer system further includes a plurality of second type input devices. The method further includes the following steps. When a number of the first type input devices equals a number of the second type input devices, a device corresponding relationship between the first type input devices and the second type input devices is defined according to a priority sequence between the first type devices and a priority sequence between the second type devices. When a second type input data generated by one of the second type input devices is received, the second type input data is transmitted to one of the application programs according to the device corresponding relationship.

In one embodiment of the invention, the input devices are n first type input devices, where n is a positive integer larger than 2. The personal computer system further includes m second type input devices, where m is a positive integer larger than 1 and n is larger than m. The method further includes the following. A device corresponding relationship between (m-1) first type input devices among the n first type input devices and (m-1) second type input devices among the m second type input devices is defined according to a priority sequence between the first type devices and a priority sequence between the second type devices, wherein the (m-1) first type input devices have higher priority in the priority sequence between the first type devices and the (m-1) second type input devices have higher priority in the priority sequence between the second type devices. When a second type input data generated by one of the second type input devices is received, whether the second type input device generating the second type input data is in the (m-1) second type input devices having higher priority in the priority sequence between the second type devices is determined. If the second type input device is in the (m-1) second type input devices, the second type input data is transmitted to one of the application programs according to the device corresponding relationship. If the second type input device is not in the (m-1) second type input devices, the second type input data is transmitted to the assigned application program when the second type input device is assigned to operate one of the application programs, and the second type input data is transmitted to one of the application programs according to a usage state of the first type input devices when the second type input device is not assigned to operate any of the application programs.

In one embodiment of the invention, wherein a priority sequence consists in the input devices having a same device type. In which, the input device built-in in the personal computer system has a higher priority in the priority sequence than that of the input device externally connected to the personal computer system, and when a number of the input device externally connected to the personal computer system is larger than 2, each of the input device externally connected to the personal computer system is prioritized in the priority sequence by a port number or a connecting order.

In one embodiment of the invention, wherein the display screen is displayed by one or more display devices of the personal computer system.

From another perspective, the invention is directed to a personal computer system including a plurality of input devices, a plurality of application program modules, and a multiple output control module. Here, the application program modules are configured to provide a plurality of application programs. The multiple output control module is coupled to the input devices and the application program modules. When the personal computer system receives a plurality of input data generated by the input devices respectively, the multiple output control module transmits each of the input data to one of the application programs according to an identification information of each of the input devices. Moreover, each of the application programs generates an output result according to the received input data and displays the output result on a corresponding application program interface, wherein all of the application program interfaces displaying the corresponding output results are in one display screen of the personal computer system. In one embodiment of the invention, the input devices include at least one first type input device and/or at least one second type input device.

In one embodiment of the invention, the personal computer system further includes a built-in input device driving module. The built-in input device driving module is coupled to the multiple output control module. When the input device is built-in in the personal computer system, the multiple output control module receives the input data generated by the input device through the built-in input device driving module, and the built-in input device driving module adopts a corresponding device type as the identification information of each of the input devices.

In one embodiment of the invention, the personal computer system further includes an external input device identification recognition module. The external input device identification recognition module is coupled to the multiple output control module. When the input devices are externally connected to the personal computer system respectively through a port, the multiple output control module receives the input data generated by the input devices through the external input device identification recognition module. The external input device identification recognition module adopts a port number of the port and a corresponding device type as the identification information of each of the input devices.

In one embodiment of the invention, the input devices are a plurality of first type input devices and the personal computer system further includes a second type input device coupled to the multiple output control module. Here, when the personal computer system receives a second type input data generated by the second type input device, the multiple output control module determines whether the second type input device is assigned to operate one of the application programs. When the second type input device is determined to being assigned to operate one of the application programs, the multiple output control module transmits the second type input data to the assigned application program. When the second type input device is determined not being assigned to operate any of the application programs, the second type input data is transmitted to one of the application programs according to a usage state of the first type input devices.

In one embodiment of the invention, when the multiple output control module transmits the second type input data according to the usage state of the first type input devices, the multiple output control module determines whether at least one of the first type input devices is in uses. When at least one of the first type input devices is determined as being in use, the multiple output control module acquires one of the at least one first type input device in use according to a priority sequence between the first type devices and transmits the second type input data to the application program corresponding to the acquired first type input device. When there is no first type input device in use, the multiple output control module acquires the application program last receiving an input data generated by the first type input devices and transmits the second type input data to the acquired application program.

In one embodiment of the invention, the input devices are a plurality of first type input devices and the personal computer system further includes a plurality of second type input devices coupled to the multiple output control module. When a number of the first type input devices equals a number of the second type input devices, the multiple output control module defines a device corresponding relationship between the first type input devices and the second type input devices according to a priority sequence between the first type devices and a priority sequence between the second type devices. When the personal computer system receives a second type input data generated by one of the second type input devices, the multiple output control module transmits the second type input data to one of the application programs according to the device corresponding relationship.

In one embodiment of the invention, the input devices are n first type input devices, where n is a positive integer larger than 2. The personal computer system further includes m second type input devices coupled to the multiple output control module, where m is a positive integer larger than 1 and n is larger than m. The multiple output control module defines a device corresponding relationship between (m-1) first type input devices among the n first type input devices and (m-1) second type input devices among the m second type input devices according to a priority sequence between the first type devices and a priority sequence between the second type devices, wherein the (m-1) first type input devices have higher priority in the priority sequence between the first type devices and the (m-1) second type input devices have higher priority in the priority sequence between the second type devices. When the personal computer system receives the second type input data generated by one of the second type input devices, the multiple output control module determines whether the second type input device generating the second type input data is in the (m-1) second type input devices. When the second type input device is in the (m-1) second type input devices, the multiple output control module transmits the second type input data to one of the application programs according to the device corresponding relationship. When the second type input device is not in the (m-1) second type input devices, the multiple output control module transmits the second type input data to the assigned application program when the second type input device is assigned to operate one of the application programs, and transmits the second type input data to one of the application programs according to a usage state of the first type input devices when the second type input device is not assigned to operate any one of the application programs.

In one embodiment of the invention, wherein a priority sequence consists in the input devices having a same device type, in which the input device built-in in the personal computer system has a higher priority in the priority sequence than that of the input device externally connected to the personal computer system, and when a number of the input device externally connected to the personal computer system is larger than 2, each of the input device externally connected to the personal computer system is prioritized in the priority sequence by a port number or a connecting order.

In one embodiment of the invention, the personal computer system further includes at least one display device coupled to the application program modules. Herein, the display screen is displayed by the same or different display devices.

In light of the foregoing, the invention transmits the input data generated by the input device to the corresponding application program according to the identification information of the input device. As a consequence, the personal computer system having a plurality of input devices can receive data input by different users utilizing different input devices and can display output results on different application program interfaces respectively. Since the input data generated by different input devices do not interfere one another, the personal computer system can support operations of multiple users and therefore generate multiple outputs.

In order to make the aforementioned and other features and advantages of the invention more comprehensible, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a block diagram illustrating a personal computer system according to an embodiment of the invention.

FIG. 2 is a block diagram illustrating a personal computer system according to another embodiment of the invention.

FIG. 3 is a flow chart illustrating an operation method of multiple outputs according to an embodiment of the invention.

FIG. 4 is a flow chart illustrating an operation method of multiple outputs according to another embodiment of the invention.

FIG. 5 is a flow chart illustrating an operation method of multiple outputs according to another embodiment of the invention.

FIG. 6 is a flow chart illustrating an operation method of multiple outputs according to another embodiment of the invention.

### DESCRIPTION OF EMBODIMENTS

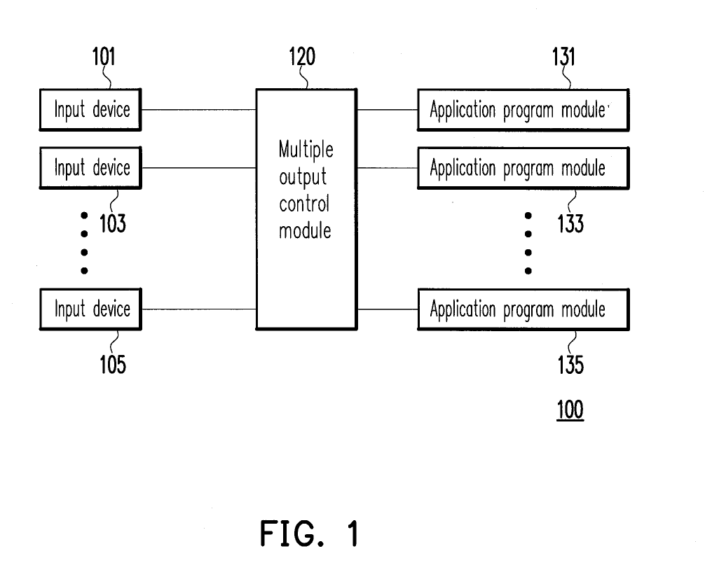

FIG. 1 is a block diagram illustrating a personal computer system according to an embodiment of the invention. Referring to FIG. 1, a personal computer system 100 includes a plurality of input devices (e.g. input devices 101,103, 105), a multiple output control module 120, and a plurality of application program modules (e.g. application program modules 131, 133, 135). The personal computer system 100 is a desktop computer system, a notebook computer system or so on, and the invention is not limited thereto.

In the present embodiment, the input devices of the personal computer system 100 are keyboards, mice, joysticks, track balls, or so on. Each of the application program modules is configured to provide different application programs (i.e. desktop application program, browser application program, word processing application program, or so on) respectively. The multiple output control module 120 is connected to the input devices and the application program modules. Also, the multiple output control module 120 provides a multiple output control mechanism for the personal computer system 100 to receive input data generated by different input devices simultaneously and display corresponding output results on different application program interfaces. In the present embodiment, each of the application program interfaces is, for example, an active window, and the active windows may be generated by the same or different application program modules. To be specific, one application program module is for providing a kind of application program, but may generate one or more active windows for receiving the input data generated by different input devices respectively. An operation method of the multiple output control module 120 is illustrated in details with accompanying figures in the following.

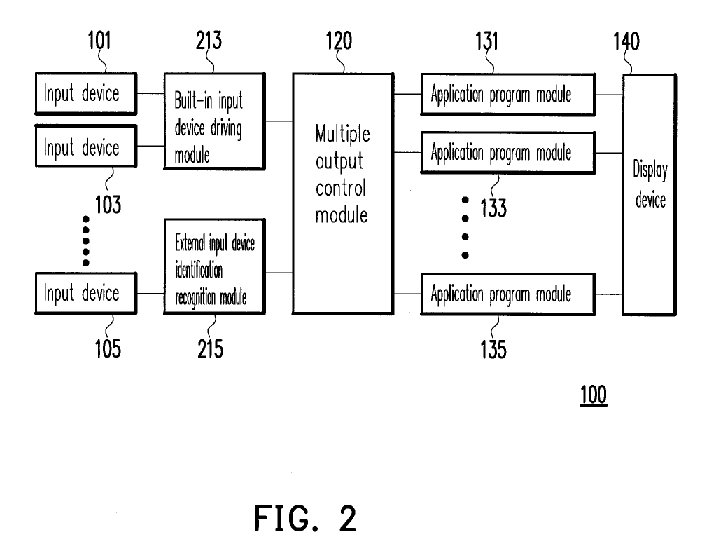

In order to transmit the input data generated by different input devices to suitable/appropriate application programs, the personal computer system 100 needs to verify an identification information of each input device generating the input data. FIG. 2 is a block diagram illustrating a personal computer system according to another embodiment of the invention. In the present embodiment, the personal computer system 100 further includes a built-in input device driving module 213, an external input device identification recognition module 215, and a display device 140. Here, the built-it input device driving module 213 and the external input device identification recognition module 215 are coupled to the multiple output control module 120, and the display device 140 is coupled to the application program modules 131, 133, 135.

Assuming the input devices 101, 103 are built-in in the personal computer system 100, the input data generated by the input devices 101, 103 may be input into the built-in input device driving module 213 through a micro-processor (not shown) of the personal computer system 100, and then transmitted to the multiple output control module 120. Since the input devices 101, 103 are built-in in the personal computer system 100, the built-in input device driving module 213 can acquire device types of the input devices 101, 103 to adopt the device types as their identification information.

In addition, assuming the input device 105 is externally connected to the personal computer system 100 through a port (i.e. a universal serial bus (USB) port, not shown), the input data generated by the input device 105 is then transmitted to the multiple output control module 120 through the port and the external input device identification recognition module 215. In the present embodiment, the external input device identification recognition module 215 determines which of the ports is utilized by the input device 105 for connecting to the personal computer system 100. Moreover, the external input device identification recognition module 215 determines the device type of the input device 105 according to the content of the input data, so as to adopt the corresponding port number and the device type as an identification information of the input device 105.

In the present embodiment, all of the application program interfaces for displaying output results generated by the application programs are in one and the same display screen of the personal computer system 100.

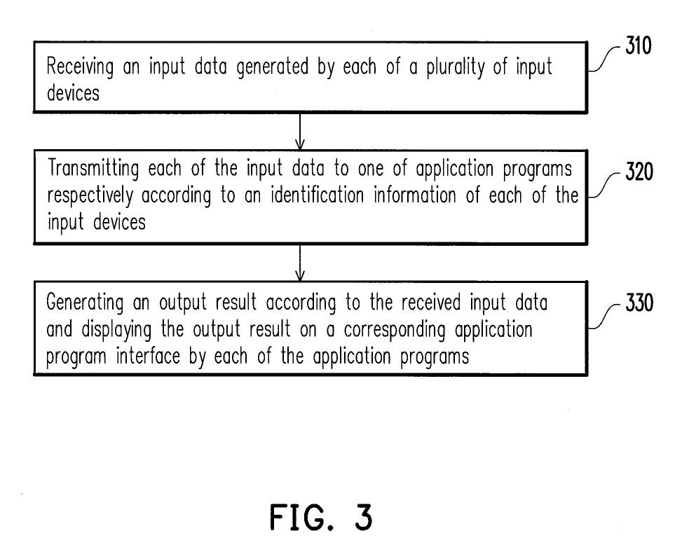

FIG. 3 is used to illustrate steps in an operation method of multiple outputs in the following. Referring to FIGS. 2 and 3, as shown in step 310, the personal computer system 100 receives a plurality of input data generated by a plurality of input devices (e.g. input devices 101, 103, 105). In the present embodiment, the input devices include one or more first type input devices and/or one or more second type input devices. For example, the first type input device is an input device of a mouse or a keyboard. The second input device is another input device of a mouse or a keyboard, for example. After the personal computer system 100 receives the input data, the built-in input device driving module 213 or the external input device identification recognition module 215 defines an identification information of each input device generating the input data according to a connection state between each of the input devices and the personal computer system 100.

In step 320, the multiple output control module 120 transmits all of the received input data to a corresponding application program (e.g. an application program provided by the application program module 131, 133, or 135) respectively according to an identification information of each of the input devices.

In step 330, each of the application programs respectively generates an output result according to the received input data/each received data and displays the output result on a corresponding application program interface.

As depicted in FIG. 3, by pre-setting each input device for controlling a specific application program, the multiple output control module 120 can transmit the input data generated to the specific application program according to the identification information of the input device. Thereafter, the application program generates and displays the output result. It should be noted that there is a one-to-one relationship between the input devices and the application program interfaces displaying the output results. Accordingly, when multiple users operate a plurality of input devices of the personal computer system 100 simultaneously, the personal computer system 100 can process the input data generated by different input devices individually, and display a plurality of output results generated in different application program interfaces at the same time. When different users operate different input devices respectively, they will not interfere with each other. For instance, a first user and a second user may operate different input devices respectively, and view the corresponding output result in an application program interface A and an application program interface B. In which, the application program interface A and the application program interface B may be generated by the same application program provided by one application program module, or may be generated by different application programs provided by different application program modules. However, both of the application program interface A and the application program interface B are displayed in a same display screen of the personal computer system 100.

It should be noted that although the present embodiment is illustrated by using the personal computer system 100 in FIG. 2 as an example, the invention does not limit the connection state between each of the input devices and the personal computer system 100. In other words, the personal computer system 100 can receive input data generated by a plurality of built-in input devices simultaneously and generate multiple output results correspondingly. Furthermore, the personal computer system 100 can receive input data generated by a plurality of external input devices simultaneously and generate multiple output results correspondingly. The personal computer system 100 can also receive input data generated by a plurality of built-in and external input devices simultaneously and generate multiple outputs correspondingly.

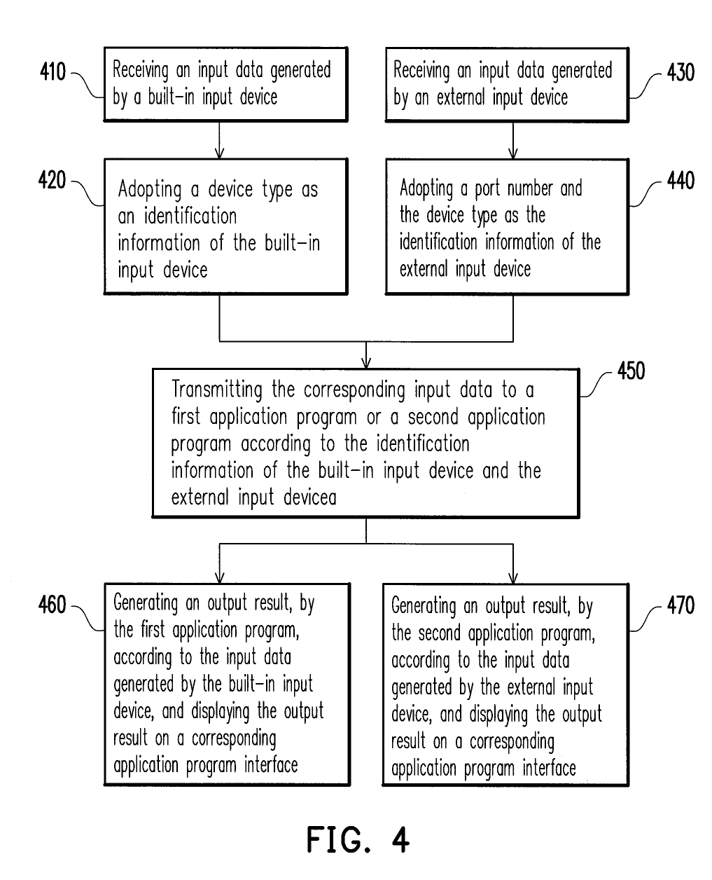

FIG. 4 is a flowchart showing an operation method of multiple outputs according to another embodiment of the invention. The present embodiment adopts a personal computer system having a built-in input device and an external input device as an example to describe steps in the operation method of multiple outputs. It is assumed that the built-in input device is assigned to operate a first application program in the personal computer system and the external input device is assigned to operate a second application program in the present embodiment.

When a first user operates the personal computer system through the built-in input device, as shown in step 410, the personal computer system receives an input data generated by the built-in input device, and a built-in input device driving module in the personal computer system sets an identification information of the built-in input device according to a device type thereof in step 420. During this time, when another user operates the personal computer system through an external input device as depicted in step 430, the personal computer system then receives an input data generated by the external input device. Moreover, in step 440, the external input device identification recognition module in the personal computer system sets an identification information of the external input device according to a corresponding port number and the device type.

When the multiple output control module in the personal computer system receives the input data generated by the built-in input device and the external input device through the built-in input device driving module and the external input device identification recognition module respectively, the multiple output control module transmits the input data respectively generated by the built-in and the external input devices to the corresponding first application program and second application program through the identification information of the built-in and the external input devices in step 450.

As depicted in step 460, after receiving the input data generated by the built-in input device, the first application program generates an output result according to the input data and displays the output result on a corresponding application program interface. As shown in step 470, after receiving the input data generated by the external input device, the second application program generates an output result according to the input data and displays the output result on a corresponding application program interface.

In one embodiment, two application program interfaces used for respectively displaying the output results generated by the first and the second application programs can be displayed on the same display device of the personal computer system through different windows. In another embodiment, the two application program interfaces within the same display screen can also be displayed on different display devices of the personal computer system, by extending the desktop of the personal computer system.

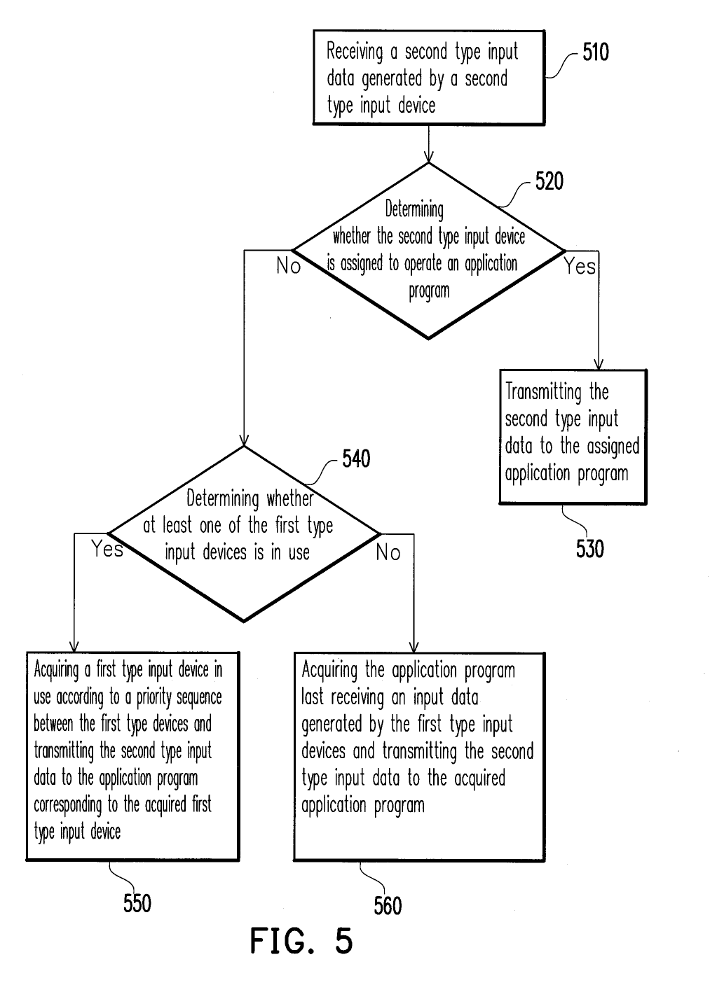

FIG. 5 is a flow chart illustrating an operation method of multiple outputs according to another embodiment of the invention. In the present embodiment, a personal computer system includes a plurality of first type input devices and one second type input device. For example, the first type input devices are input devices of mice or keyboards, and the second type input device is another type of input devices of mice or keyboards. Herein, each of the first type input devices is adopted for controlling different application programs/application program interfaces respectively. When receiving a plurality of input data generated by a plurality of first type input devices, the multiple output control module in the personal computer system transmits the corresponding input data to a suitable application program according to an identification information of each of the first type input devices as shown in the flowchart of FIG. 3, for example. Steps of the multiple output control module determining which of the application programs is controlled by the second type input device is illustrated below.

As depicted in step 510, when a user operates the second type input device for input, the personal computer system receives a second type input data generated by the second type input device. In step 520, the multiple output control module determines whether the second type input device is assigned to operate a specific application program/application program interface. For instance, the user can pre-set the application program to be controlled by the second type input device or select the application program to be controlled when inputting data.

When the second type input device is assigned to operate the specific application program, the multiple output control module then, as shown in step 530, transmits the second type input data to the assigned application program so as to generate an output result expected by the user.

When the second type input device is not assigned to operate any of the application programs, the multiple output control module determines which of the application programs is the second type input data transmitted to according to a usage state of all of the first type input devices. In details, as shown in step 540, the multiple output control module determines whether at least one first type input device in use (that is, the first type input device being operated by the user) is existing among all of the first type input devices.

When at least one first type input device is in use, as illustrated in step 550, the multiple output control module then acquires one of the first type input devices from all of the first type input devices in use according to a priority sequence between the first type devices. To be specific, among all of the first type input devices, the first type input device built-in in the personal computer system has a higher priority in the priority sequence between the first type devices than that of the first type input device externally connected to the personal computer system. If a number of the first type input device externally connected to the personal computer system is larger than 2, the priority in the priority sequence of each of the first type input device externally connected to the personal computer system is corresponding to a port number or an order sequence of connecting to the personal computer system. For example, a first type input device corresponding to a smaller port number or earlier connected to the personal computer system may has a higher priority in the priority sequence between the first type devices.

Assuming that the device type of the first type input device is keyboard, if the personal computer system has one built-in keyboard and two external keyboards connected to the personal computer system through different USB ports, the built-in keyboard has the highest priority in the priority sequence between the first type devices. The priority of each of the external keyboards is corresponding to the corresponding USB port number. In the present embodiment, the external keyboard corresponds to the smaller USB port number has a higher priority.

In the present embodiment, the multiple output control module acquires the first type input devices having the highest priority in the priority sequence among all of the first type input devices in use, for example. The multiple output control module then transmits the second type input data to the application program corresponding to the acquired first type input device so as to generate the output result.

When none of the first type input devices is in use, as depicted in step 560, the multiple output control module acquires the application program receiving a latest input data generated by the first type input devices from all of the application programs. The multiple output control then transmits the second type input data to the acquired application program to generate the output result.

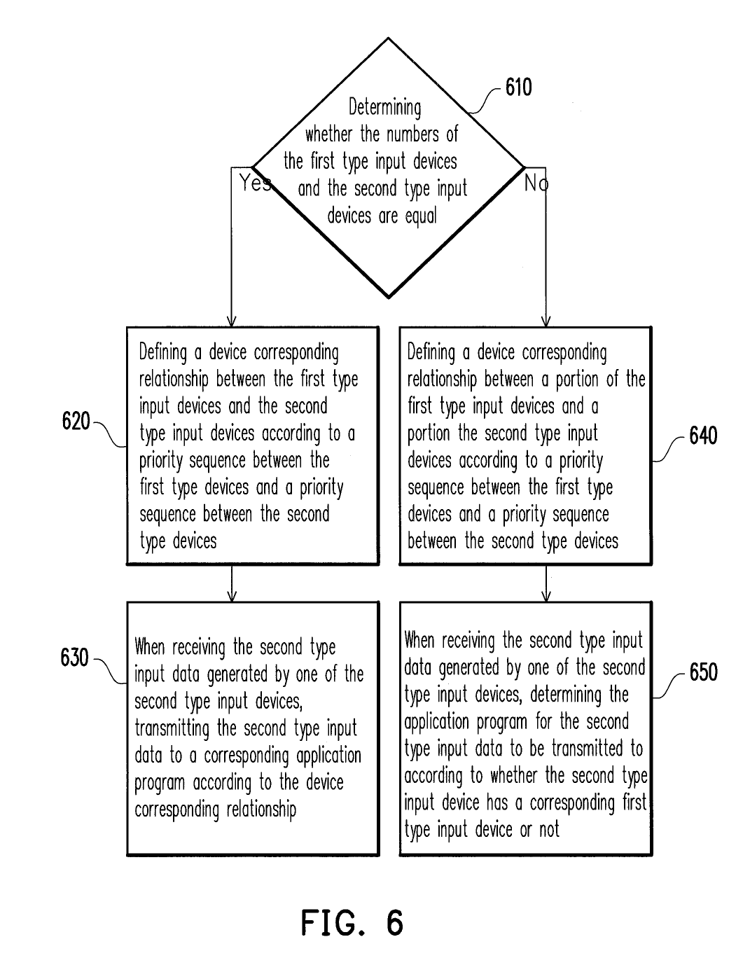

FIG. 6 is a flowchart illustrating an operation method of multiple outputs according to another embodiment of the invention. In the present embodiment, the personal computer system includes a plurality of first type input devices and a plurality of second type input devices. For instance, the first type input devices are input devices of mice or keyboards, and the second type input devices are another type of input devices of mice or keyboards. In the present embodiment, assuming when receiving a plurality of input data generated by a plurality of first type input devices, the multiple output control module in the personal computer system transmits the input data to suitable application programs respectively according to the identification information of the first type input devices. In the following, the method of the multiple output control module determining the application program to be operated by each of the second type input devices according to the number of the first type input devices and the second type input devices is described.

As illustrated in step 610, the multiple output control module determines whether the number of the first type input devices and the number of the second type input devices are equal.

When the numbers are equal, the multiple output control module defines a device corresponding relationship between each of the first type input devices and each of the second type input devices according to a priority sequence between the first type devices and a priority sequence between the second type devices as provided in step 620. In which, the manner of defining the priority sequence between the second type devices is the same as or similar to the manner of defining the priority sequence between the first type devices, therefore will not be described herein.

As shown in step 630, when the personal computer system receives a second type input data generated by any one of the second type input devices, the multiple output control module transmits the second type input data to a corresponding application program according to the device corresponding relationship between the first type input devices and the second type input devices.

When the number of the first type input devices does not equal the number of the second type input devices, the multiple output control module defines the device corresponding relationship between a portion of the first type input devices and a portion of the second type input devices according to the priority sequence between the first type devices and the priority sequence between the second type devices as shown in step 640. In step 650, when the personal computer system receives the second type input data generated by any one of the second type input devices, the multiple output control module determines which of the application programs the second type input data should be transmitted to according to whether the second type input device has a correspond first type input device.

For better illustration, it is assumed that the number of the first type input devices is n (n is a positive integer larger than 2) and the number of the second type input devices is m (m is a positive integer larger than 1), where n is larger than m. In one embodiment, the multiple output control module defines a device corresponding relationship between (m-1) first type input devices and (m-1) second type input devices according to the priority sequence between the first type devices and the priority sequence between the second type devices, wherein the (m-1) first type input devices have higher priority in the priority sequence between the first type devices and the (m-1) second type input devices have higher priority in the priority sequence between the second type devices.

When the personal computer system receives the second type input data generated by one of the second type input devices, if the second type input device is in the (m-1) second type input devices having higher priority in the priority sequence between the second type devices, then this second type input device has a corresponding first type input device. Thus, the multiple output control module transmits the second type input data to the corresponding application program according to the defined device corresponding relationship.

If the second type input device generating the second type input data is not in the (m-1) second type input devices having higher priority in the priority sequence between the second type devices (that is, the second type input device is a second type input device having the lowest priority) and therefore does not have a corresponding first type input device, the multiple output control module then transmits the second type input data to an assigned application program when the second type input device is assigned to operate one of the application programs by the user. When the second type input device is not assigned to operate any of the application programs, the multiple output control module determines which of the application programs is the second type input data transmitted to according to a usage state of all of the first type input devices. Since the operation method of the multiple output control module include steps identical or similar to those shown in FIG. 5 when the second type input device does not have the corresponding first type input device, the operation method is omitted hereinafter.

In summary, the personal computer system and the operation method of multiple outputs as described in the invention prevent the input data generated by the input devices of the personal computer system from conflicting one another, and are capable of displaying the output results generated from different input data on different application program interfaces correspondingly. Accordingly, the personal computer system can receive operations of multiple users performed through different input devices simultaneously and display the corresponding output results on different application program interfaces displayed in the same display screen simultaneously.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An operation method of multiple outputs for a personal computer system comprising a plurality of input devices, the operation method comprising:
receiving an input data respectively generated by each of the input devices;
transmitting the input data generated by each of the input devices to one of a plurality of application programs respectively according to an identification information of each of the input devices; and
generating an output result according to the received input data and displaying the output result on a corresponding application program interface respectively by each of the application programs, wherein all of the application program interfaces displaying the corresponding output results are in one display screen of the personal computer system.

2. The operation method of multiple outputs as claimed in claim 1, wherein the input devices comprise at least one first type input device and/or at least one second type input device.

3. The operation method of multiple outputs as claimed in claim 1, wherein after the step of receiving the input data generated by each of the input devices, and the operation method further comprises:
for each of the input devices, when the input device is externally connected to the personal computer system through a port, adopting a port number of the port and a device type as the identification information of the input device; and
when the input device is built-in in the personal computer system, using the device type as the identification information.

4. The operation method of multiple outputs as claimed in claim 1, wherein the input devices are a plurality of first type input devices and the personal computer system further comprises a second type input device, and the operation method further comprises:
receiving a second type input data generated by the second type input device;
determining whether the second type input device is assigned to operate one of the application programs;
when the second type input device is determined to being assigned to operate one of the application programs, transmitting the second type input data to the assigned application program; and
when the second type input device is determined not being assigned to operate any of the application programs, transmitting the second type input data to one of the application programs according to a usage state of the first type input devices.

5. The operation method of multiple outputs as claimed in claim 4, wherein the step of transmitting the second type input data to one of the application programs according to the usage state of the first type input devices comprises:
determining whether at least one of the first type input devices is in use;
if yes, acquiring one of the at least one first type input device in use according to a priority sequence between the first type devices and transmitting the second type input data to the application program corresponding to the acquired first type input device; and
if not, acquiring the application program last receiving an input data generated by the first type input devices and transmitting the second type input data to the acquired application program.

6. The operation method of multiple outputs as claimed in claim 1, wherein the input devices are a plurality of first type input devices and the personal computer system further comprises a plurality of second type input devices, and the operation method further comprises:
when a number of the first type input devices equals a number of the second type input devices, defining a device corresponding relationship between the first type input devices and the second type input devices according to a priority sequence between the first type devices and a priority sequence between the second type devices; and
when receiving a second type input data generated by one of the second type input devices, transmitting the second type input data to one of the application programs according to the device corresponding relationship.

7. The operation method of multiple outputs as claimed in claim 1, wherein the input devices are n first type input devices while n is a positive integer larger than 2, and the personal computer system further comprises m second type input devices while m is a positive integer larger than 1 and n is larger than m, the operation method further comprises:
according to a priority sequence between the first type devices and a priority sequence between the second type devices, defining a device corresponding relationship between (m-1) first type input devices among the n first type input devices and (m-1) second type input devices among the m second type input devices, wherein the (m-1) first type input devices have higher priority in the priority sequence between the first type devices and the (m-1) second type input devices have higher priority in the priority sequence between the second type devices;
when receiving a second type input data generated by one of the second type input devices, determining whether the second type input device generating the second type input data is in the (m-1) second type input devices having higher priority in the priority sequence between the second type devices;
if yes, transmitting the second type input data to one of the application programs according to the device corresponding relationship; and
if not, when the second type input device is assigned to operate one of the application programs, transmitting the second type input data to the assigned application program, and when the second type input device is not assigned to operate any of the application programs, transmitting the second type input data to one of the application programs according to a usage state of the first type input devices.

8. The operation method of multiple outputs as claimed in claim 1, wherein a priority sequence consists in the input devices having a same device type, in which the input device built-in in the personal computer system has a higher priority in the priority sequence than that of the input device externally connected to the personal computer system, and when a number of the input device externally connected to the personal computer system is larger than 2, each of the input device externally connected to the personal computer system is prioritized in the priority sequence by a port number or a connecting order.

9. The operation method of multiple outputs as claimed in claim 1, wherein the display screen is displayed by one or more display devices of the personal computer system.

10. A personal computer system, comprising:
a plurality of input devices;
a plurality of application program modules, configured to provide a plurality of application programs; and
a multiple output control module, coupled to the input devices and the application program modules,
wherein when the personal computer system receives an input data respectively generated by each of the input devices, the multiple output control module transmits the input data generated by each of the input devices to one of the application programs respectively according to an identification information of each of the input devices,
and each of the application programs generates an output result according to the received input data and displays the output result on a corresponding application program interface, wherein all of the application program interfaces displaying the corresponding output results are in one display screen of the personal computer system.

11. The personal computer system as claimed in claim 10, wherein the input devices comprises at least one first type input device and/or at least one second type input device.

12. The personal computer system as claimed in claim 10, further comprising:
a built-in input device driving module, coupled to the multiple output control module, wherein when the input device is built-in in the personal computer system, the multiple output control module receives the input data generated by the input device through the built-in input device driving module, and the built-in input device driving module adopts a corresponding device type as the identification information of each of the input devices.

13. The personal computer system as claimed in claim 10, further comprising:
an external input device identification recognition module, coupled to the multiple output control module, wherein when the input devices are externally connected to the personal computer system respectively through a port, the multiple output control module receives the input data generated by the input devices through the external input device identification recognition module, and the external input device identification recognition module adopts a port number corresponding to the port and a corresponding device type as the identification information of each of the input devices.

14. The personal computer system as claimed in claim 10, wherein the input devices are a plurality of first type input devices, and the personal computer system further comprises:
a second type input device, coupled to the multiple output control module,
wherein when the personal computer system receives a second type input data generated by the second type input device, the multiple output control module determines whether the second type input device is assigned to operate one of the application programs,
when the second type input device is determined to being assigned to operate one of the application programs, the multiple output control module transmits the second type input data to the assigned application program,
when the second type input device is determined not being assigned to operate any of the application programs, the multiple output control module transmits the second type input data to one of the application programs according to a usage state of the first type input devices.

15. The personal computer system as claimed in claim 14, wherein when transmitting the second type input data to one of the application programs according to the usage state of the first type input devices, the multiple output control module determines whether at least one of the first type input devices is in use,
if yes, the multiple output control module acquires one of the at least one first type input device in use according to a priority sequence between the first type devices and transmits the second type input data to the application program corresponding to the acquired first type input device; and
if not, the multiple output control module acquires the application program last receiving an input data generated by the first type input devices and transmits the second type input data to the acquired application program.

16. The personal computer system as claimed in claim 10, wherein the input devices are a plurality of first type input devices, and the personal computer system further comprises:
a plurality of second type input devices, coupled to the multiple output control module,
wherein when a number of the first type input devices equals a number of the second type input devices, the multiple output control module defines a device corresponding relationship between the first type input devices and the second type input devices according to a priority sequence between the first type devices and a priority sequence between the second type devices, and
when the personal computer system receives a second type input data generated by one of the second type input devices, the multiple output control module transmits the second type input data to one of the application programs according to the device corresponding relationship.

17. The personal computer system as claimed in claim 10, wherein the input devices are n first type input devices while n is a positive integer larger than 2, and the personal computer system further comprises:
m second type input devices, coupled to the multiple output control module, wherein m is a positive integer larger than 1 and n is larger than m,
wherein the multiple output control module defines a device corresponding relationship between (m-1) first type input devices among the n first type input devices and (m-1) second type input devices among the m second type input devices according to a priority sequence between the first type devices and a priority sequence between the second type devices, wherein the (m-1) first type input devices have higher priority in the priority sequence between the first type devices and the (m-1) second type input devices have higher priority in the priority sequence between the second type devices,
when the personal computer system receives a second type input data generated by one of the second type input devices, the multiple output control module determines whether the second type input device generating the second type input data is in the (m-1) second type input devices having higher priority in the priority sequence between the second type devices;
if yes, the multiple output control module transmits the second type input data to one of the application programs according to the device corresponding relationship; and
if not, when the second type input device is assigned to operate one of the application programs, the multiple output control module transmits the second type input data to the assigned application program, and when the second type input device is not assigned to operate any of the application programs, the multiple output control module transmits the second type input data to one of the application programs according to a usage state of the first type input devices.

18. The personal computer system as claimed in claim 10, wherein a priority sequence consists in the input devices having a same device type, in which the input device built-in in the personal computer system has a higher priority in the priority sequence than that of the input device externally connected to the personal computer system, and when a number of the input device externally connected to the personal computer system is larger than 2, each of the input device externally connected to the personal computer system is prioritized in the priority sequence by a port number or a connecting order.

19. The personal computer system as claimed in claim 10, further comprising:
at least one display device, coupled to the application program modules, wherein the display screen is displayed by the same or different display devices in the at least one display device.
